(19) United States
(12) Patent Application Publication
(10) Pub. No.: US 2015/0059243 A1
(43) Pub. Date: Mar. 5, 2015

(54) METHOD AND ASSEMBLY FOR GROWING PLANTS

(71) Applicant: TRANS-WORLD FOODS PTY LIMITED, West Gosford, New South Wales (AU)

(72) Inventor: Stanley Parker, Wamberal (AU)

(73) Assignee: Trans-World Food PTY Limited, West Gosford, New South Wales (AU)

(21) Appl. No.: 14/389,795

(22) PCT Filed: Feb. 21, 2013
(86) PCT No.: PCT/AU2013/000159

§ 371 Date: Oct. 1, 2014

(30) Foreign Application Priority Data
Feb. 22, 2012 (AU) 2012900667

(51) Int. Cl. A01G 9/02; A01G 27/00; A01G 9/24

(52) U.S. Cl. CPC A01G 9/02; A01G 9/246; A01G 27/00
USPC 47/66.6; 47/65.5; 47/79

(57) ABSTRACT

An assembly for growing plants which includes a frame with a pair of laterally spaced apart frame members, and each the frame member has a main housing to be located above a surface; a longitudinally extending main shaft which extends between the main housings, and the main shaft defines a longitudinal axis about which the main shaft can rotate; an end plate positionable adjacent each the main housing and securable to the main shaft so as to rotate about the axis; and each the end plate has at least two arms; a distal end of each the arm has an arm housing for supporting an arm shaft extending laterally between corresponding arms of corresponding end plates; and a cradle for growing plants which is securable to the arm shaft and movable about the main shaft.

### FIELD OF THE INVENTION

The present invention relates to a method and assembly for growing plants and in particular to an apparatus to accelerate the production of food in a confined space.

### BACKGROUND OF THE INVENTION

Over the last 20 years there has been a dramatic increase in the human population of the world. With such an increase, food supplies have dwindled and in many countries people have been pushed towards starvation. At the same time, global warming and a spreading population has reduced the amount of land available for growing food. Droughts have also lead to a lack of water available for irrigation of crops. Accordingly, there is a need for a method and assembly for quickly growing plants, and in particular food, in limited space and with limited or efficient water use.

A system allowing a grower to plant 20 or more times the food on an equivalent standing land size and having easier control of temperature, humidity and other environmental factors while also being cost effective is required.

The old cultivation method of clearing large acres of land for flat planting and if needed covering that land with buildings is very expensive. Further to regulate the temperature and humidity in such buildings is also very expensive.

Also a major problem for primary producers is the lack of a reliable source of high quality feed for livestock on a farm, particularly during adverse weather conditions such as floods or droughts. One proposed solution is the growing of barley seeds in trays in a greenhouse which are fertilized using a hydroponic system. A disadvantage of this is that the greenhouse requires considerable space and cost and may not be immune to changes in external weather conditions.

Recently, growing of fodder in trays has been proposed inside a temperature and humidity controlled container or building. In some embodiments, the trays are stacked in rows with each row providing enough fodder for feeding livestock for a day. A particular problem with existing container assemblies is the constant formation of mould in the assembly parts.

### OBJECT OF THE INVENTION

It is an object of the present invention to substantially overcome or at least ameliorate one or more of the disadvantages of the prior art, or to at least provide a useful alternative.

### SUMMARY OF THE INVENTION

There is firstly disclosed herein an assembly for growing plants including:

a frame having a pair of laterally spaced apart frame members, each said frame member having a main housing to be located above a surface;

a longitudinally extending main shaft to extend between said main housings, said main shaft defining a longitudinal axis about which said main shaft can rotate;

an end plate positionable adjacent each said main housing and securable to said main shaft to rotate about said axis;

each said end plate having at least two arms, a distal end of each said arm having an arm housing to support an arm shaft extending laterally between corresponding arms of corresponding end plates; and

a cradle to grow plants securable to said arm shaft and movable about said main shaft.

Preferably, each said frame member includes a bridge portion and a pair of longitudinally extending outwardly diverging legs, feet being positioned adjacent a distal end of said legs to be located on said surface, said main housing being located adjacent said bridge portion.

Preferably, said frame member is substantially “A” shaped.

Preferably, each said main housing includes at least one bearing to support rotation of said main shaft.

Preferably, each said end plate is a first end plate and said arm shafts are second main shafts, said assembly including second end plates located adjacent said arm housings and adapted to rotate about said second main shafts, said second end plates having at least two arms to support respective arm shafts and respective cradles.

Preferably, each said cradle includes a longitudinally extending tray located between a pair of end members, said end members having means to attach said cradle to a respective arm shaft, said tray being movable relative to said arm shaft so as to maintain said tray in a substantially horizontal orientation relative to said surface.

Preferably, said attachment means of said cradle includes a hook portion.

Preferably, including watering means operatively associated with said trays to water said plants being grown in said cradles.

Preferably, said watering means includes a pipe extending along at least one arm of at least one end plate.

Preferably, said watering means includes a pipe extending along each said arm.

Preferably, said end members of said trays include apertures to provide access for water.

Preferably, including a water collector to receive water from said watering means, said collector having a portion located closer to said surface than said trays.

Preferably, said portion includes an arcuate receiving plate extending between a pair of end members.

In another aspect, the present invention provides a bracket for supporting trays for a plant growing assembly, the bracket having:

a plate for attachment to a support structure;

a formation including a tube attached to the plate via at least one web, a first wall extending above the tube, wherein the plate, web and first wall form a channel therebetween.

Preferably, the formation includes a second wall above the tube spaced from the first wall wherein the first and second walls are adapted for mounting rollers for the trays.

The web is preferably angled 5° downwardly toward the tube.

The first and second walls preferably extend substantially vertically. The second wall is preferably located adjacent a distal peripheral end of the tube.

The plate preferably includes at least two vertically spaced longitudinal recesses having threaded apertures thereon for positioning the bracket to the support structure.

The support structure preferably includes a slidable collar fixable in position to a support beam, wherein the bracket is attached to the collar.

The present invention in another aspect provides a plant growing assembly including pairs of substantially vertical support beams spaced along the assembly;

brackets supported by the support beams on respective sides of the assembly, each bracket on one side being paired with a bracket on the other side for supporting a tray therebetween;

wherein each bracket is attached to a support beam via a slidable collar fixable in position relative to the support beam.

Each bracket is preferably in accordance with the above described first aspect.

The assembly preferably includes sets of support beams comprising a pair of side support beams and a middle support beam disposed midway between the side beams.

The side beams preferably support vertically spaced brackets on sides thereof facing the middle support beam and the middle support beams supports substantially vertically spaced brackets at each lateral side thereof,

Preferably, the assembly is formed within a closable container. The support beams preferably extend between and are mounted to the container floor and roof. The container preferably includes an air conditioning system for regulating temperature and humidity within the container.

The middle brackets are preferably positioned to be slightly higher than their corresponding side bracket such that each tray is angled about 20° downwardly towards the side brackets.

The container preferably includes side walls, a roof, a floor, an entry end and an exit end, wherein each of the entry and exit ends has doors for selectively opening and closing same. The container is mounted on the ground with the entry end elevated relative to the exit end 34 to provide a 20° downward angle from the entry end to the exit end.

The assembly preferably further includes a nutrient delivery system for distributing and collecting nutrient water to and from the tubes of the brackets. The nutrient delivery system preferably includes a conduit connected to a tank for storing nutrient water, a pump for delivering nutrient water to the conduit, distribution sub-assemblies spaced along the conduit, each sub-assembly including an inlet branch connected to a valve which is connected to an outlet branch, the inlet branch being connected to the conduit and the outlet connected to the pipes of a bracket, wherein the pipe includes spray outlet therein for allowing nutrient water to be sprayed onto a tray below the pipe. Preferably, nutrient water is supplied along one side of the assembly and excess nutrient water is collected at the other side. The excess nutrient water preferably flows into the bracket channel at the other side, wherein the tube has inlets spaced therealong to allow nutrient water to enter the tube. The excess nutrient water is then preferably transferred to a manifold connected to the tubes of the other side.

The trays preferably includes a generally flat and elongated base, end walls and side walls, wherein the side walls include a substantially corrugated plan profile which forms apertures between two adjacent trays. The end walls preferably include spaced drainage holes formed therein. Stiffener tabs are preferably formed at a lower surface of the base adjacent the end walls. The base preferably includes spaced longitudinal channels formed therein extending between the end walls. The side wall profile in plan preferably includes a series of first walls connected to offset walls spaced from the first walls towards the middle portion of the base. The apertures between adjacent trays is preferably are about 1 cm wide.

### BRIEF DESCRIPTION OF THE DRAWINGS

A preferred embodiment of the invention will now be described, by way of example only, with reference to the accompanying drawings, wherein:

FIG. 1 shows a perspective view of an assembly for growing plants in accordance with the present invention;

FIG. 2 is a perspective view of the frame of FIG. 1;

FIG. 3 is a side view of FIG. 2;

FIG. 4 is a top view of one frame member of FIG. 2;

FIG. 5 is a perspective view of the water collector as shown in FIG. 1;

FIG. 6 is a perspective view of a first carousel as shown in FIG. 1;

FIG. 7 is a front view of the first end plate of FIG. 1;

FIG. 8 is a side view of FIG. 7;

FIG. 9 is a detailed section A of FIG. 7;

FIG. 10 is a detailed section B of FIG. 7;

FIG. 11 is a front view of the second end plate of FIG. 1;

FIG. 12 is a side view of FIG. 11;

FIG. 13 is a perspective view of a cradle as shown in FIG. 1;

FIG. 14 is an end view of a middle hook of the cradle of FIG. 13;

FIG. 15 is a side view of the tray of FIG. 13;

FIG. 16 is an end view of the end plate of FIG. 13;

FIG. 17 is an end bush for use with the housing of the cradle of FIG. 13;

FIG. 18 is a pivot pin of the tray of FIG. 13;

FIG. 19 is a middle support portion for the tray of FIG. 13;

FIG. 20 is a four way manifold for use with the present invention;

FIG. 21 is a main inlet for use with the present invention;

FIG. 22 is a cross-sectional view along section AA of FIG. 21;

FIG. 23 is an external perspective view of a container for the preferred embodiment of the assembly according to the present invention;

FIG. 24 is a perspective view of the assembly;

FIG. 25 is a side perspective view of the assembly;

FIG. 26 is a front perspective view of the assembly;

FIG. 27 is a perspective view of a support beam for the assembly;

FIG. 28 shows (a) side view, (b) front view and (c) plan view of the support beam;

FIG. 29 shows a pair of support beam fixing plates;

FIG. 30 is a perspective view of a collar for the support beam;

FIG. 31 shows (a) side view, (b) front view, (c) rear view and (d) plan view of the collar;

FIG. 32 shows the attachment of the collars to a support beam;

FIG. 33 is a schematic internal view of the container where (a) is a plan view showing the positions of the support beams and (b) is an elevation view showing the positions of the collars along the support beams;

FIG. 34 is an enlarged end perspective view of a bracket for the assembly;

FIG. 35 shows (a) end view and (b) plan view of the bracket having rollers attached thereto;

FIG. 36 are perspective views of a roller for the bracket;

FIG. 37 are perspective views of a plug for the bracket;

FIG. 38 shows (a) end view and (b) front view of a joiner for the bracket;

FIG. 39 shows a portion of the nutrient delivery system for the assembly including sub-assemblies having a solenoid valve;

FIG. 40 shows the mounting of the nutrient delivery system of FIG. 17 to the assembly;

FIG. 41 is a perspective view of two trays for the assembly side by side; and

FIG. 42 shows (a) end view, (b) side cross-section view, (c) side view and (d) plan view of the tray;

FIG. 43 shows (a) elevation view and (b) cross-section view along line A-A of a modified embodiment of the container;

FIG. 44 is an extruded pipe;

FIG. 45 is a connector middle;

FIG. 46 is a connector shaft;

FIG. 47 is a connector rack;

FIG. 48 is a mounting foot;

FIG. 49 is an extended beam;

FIG. 50 is a connector shaft;

FIG. 51 is a connector shaft;

FIG. 52 is a connector rack; and

FIG. 53 is a connector rack.

### DETAILED DESCRIPTION OF THE PREFERRED EMBODIMENTS

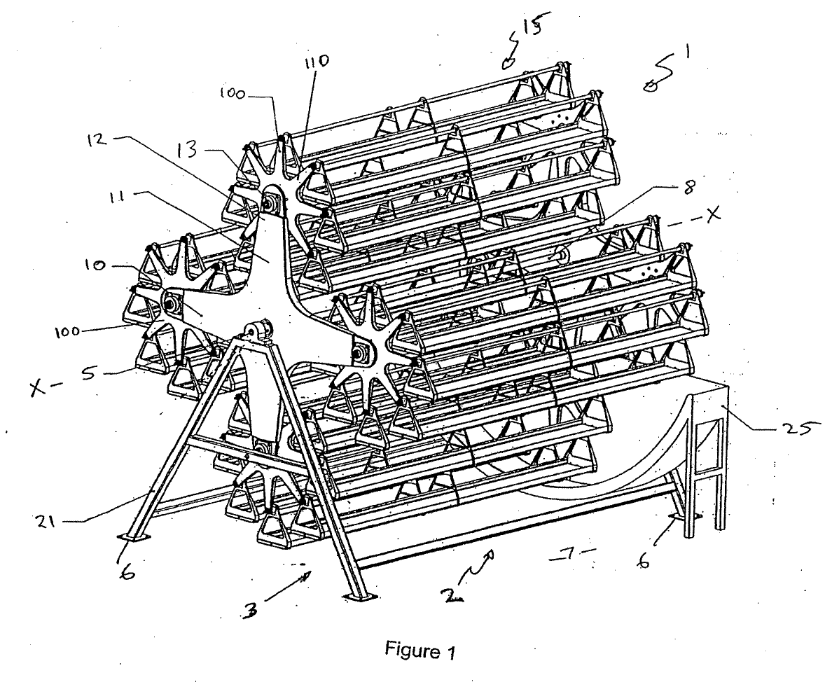

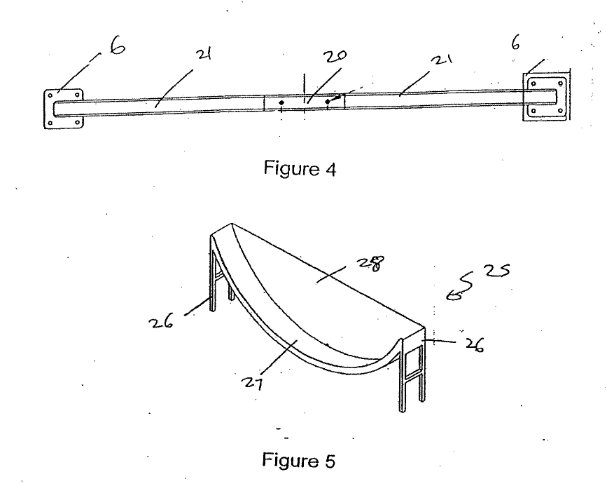

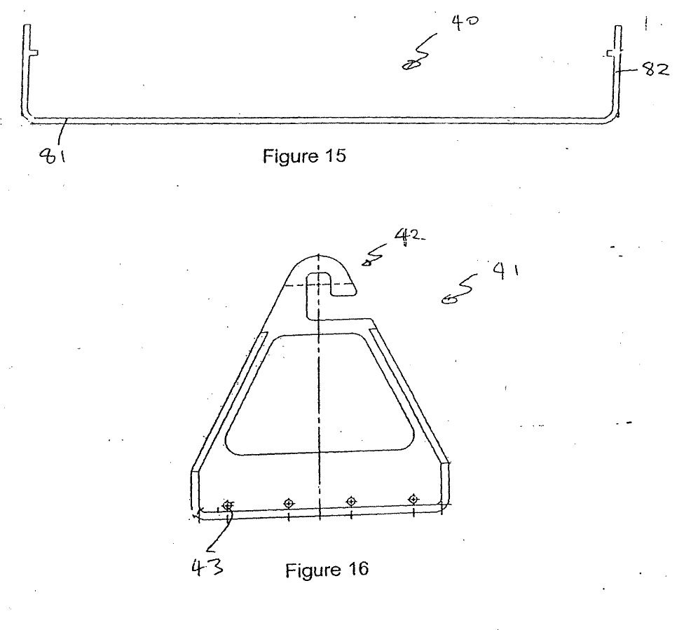

Referring to FIGS. 1 to 22, there is shown an assembly 1 for growing plants (not shown) including a frame 2 having a pair of laterally spaced apart frame members 3, each frame member 3 having a main housing 5 supported by a pair of feet 6 to be located on a surface 7. A longitudinally extending main shaft 8 extends between the main housings 5. The main shaft 8 defining a longitudinal axis XX about which the main shaft 8 can rotate relative to the main housings 5. An end plate 10 is positionable adjacent each main housing 5 and securable to the main shaft 8 to rotate about the axis XX. The main shaft 8 is preferably rotated by a drive gear (not shown) on the main shaft 8 or the like. The motor varies to speed. It should however be noted that the shaft 8 could be rotated by other typical electrical, mechanical, manual or other means. In one embodiment, water rotates the shaft 8. In another embodiment, solar panels (not shown) provide power to rotate the shaft 8. Each end plate 10 includes at least two arms 11. It should however be noted that in the preferred form there would be at least four arms 11, however any number of arms 11 can be utilized. A distal end 12 of each arm 11 has an arm housing 13 adapted to support an arm shaft 14 extending laterally between corresponding arms 11 of corresponding end plates 10. The assembly 1 further includes at least one cradle 15 to grow plants which is securable to a respective arm shaft 14 and movable about the main shaft 8 and axis XX.

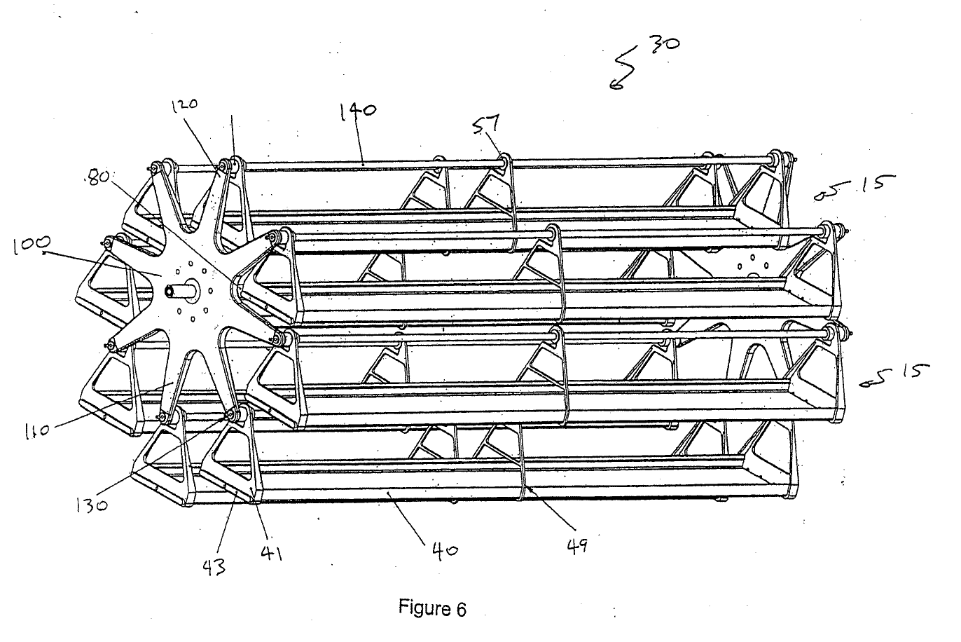

In a preferred form and as best shown in FIG. 1, there is a first end plate 10 having a plurality of arms 11 and a second end plate 100 having respective arms 110 and arms shafts 140 forming a series of carousels 30 (see FIG. 6) which support a plurality of cradles 15 (see FIG. 13). Each carousel 30 could support further carousels 30 on the respective arms 11, 110. There could conceivably be any number of carousels 30.

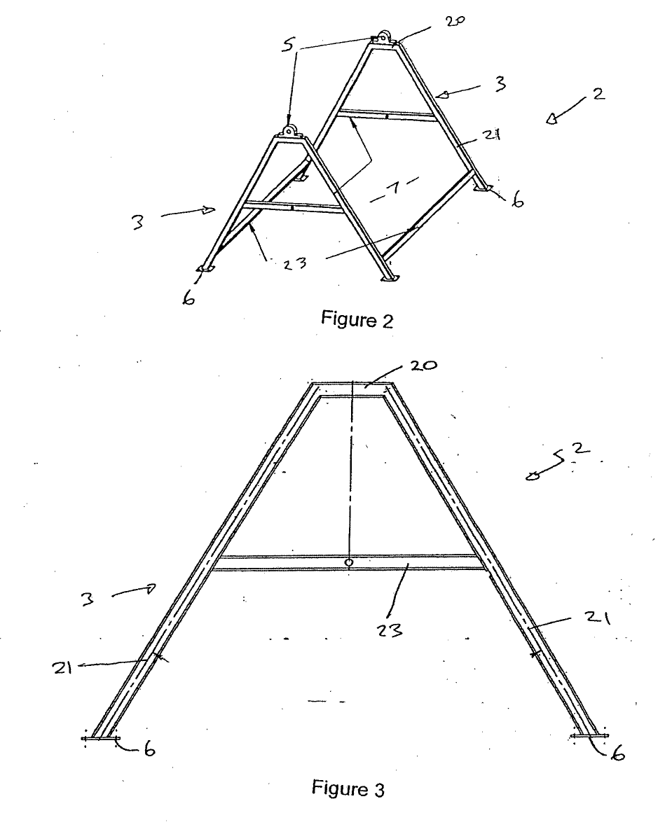

As best seen in FIGS. 2 to 4, each frame member 3 includes a bridge portion 20 and a pair of longitudinally extending outwardly diverging legs 21 to form a substantially “A-shaped” frame. However, other shaped frames could be utilized. The feet 6 are positioned adjacent a distal end of the legs 21 and the main housing 5 is located adjacent the bridge portion 20. Further support members 23 can be provided between the diverging legs 21 and between the frame members 3.

Each of the main housings 5 includes at least one bearing 23 (see FIG. 20) to support rotation of the main shaft 8 relative to the main housing 5. The bearing 24 includes a four way manifold including a slow rotation shaft fitted through a nylon bush (bearing). Holes can be provided to allow water flow between parts of the assembly or to receive piping for watering the plants.

As best seen in FIGS. 1 and 5, a water catcher 25 is provided having a pair of end members 26 supporting a generally arcuate collection plate 27 and an end plate 28. A portion of the plate 27 must be located closer to the surface 7 than the carousels 30 so that it receives the water run off. The catcher 25 collects minimum water as the plants and root system will absorb most irrigated run-off. The collector/catcher is to collect any run-off for re-use by the system.

As best seen in FIG. 6, and as discussed above, one carousel 30 is shown. Each carousel 30 includes an end plate 100 having a plurality of arms 110 with housings 130 at a distal end 120 to support arm shafts 140. The assembly 1 can have any number of carousels 30 and each end plate 100 can have any number of arms 110. The arm shafts 140 each support a cradle 15 to grow plants. Each cradle 15 can move about the arm 140 to maintain the cradle 15 in a substantially horizontal position above the surface 7. By way of gravity the cradle 15 will “rock” about the shaft 140 to maintain a generally horizontal orientation. The carousels 30 in the preferred form rotate about the main shaft 8.

As best seen in FIGS. 13 to 16, each cradle 15 includes a tray 40 extending between a pair of end members 41. The tray 40 includes a longitudinally extending base 81 and upwardly extending side walls 82 to form a dish or pan shape. The end members 41 have means 42 to attach the cradle 15 to a respective arm shaft 140. The tray 40 being movable relative to the arm shaft 140 so as to maintain the tray 40 in a substantially horizontal orientation relative to the surface 7. Each end member 41 further includes apertures 43 to provide access for water. The attachment means 42 in a preferred form includes a hook portion. However, could be any typical attachment method to a shaft.

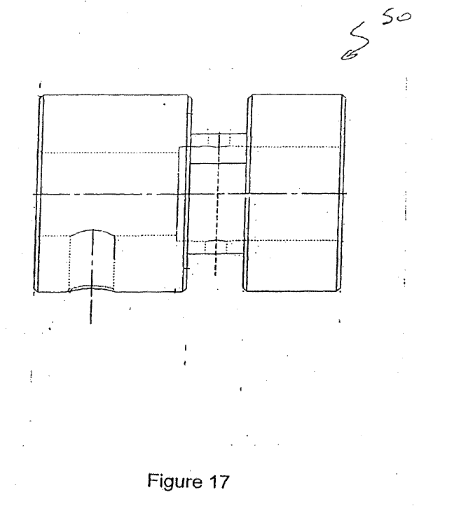

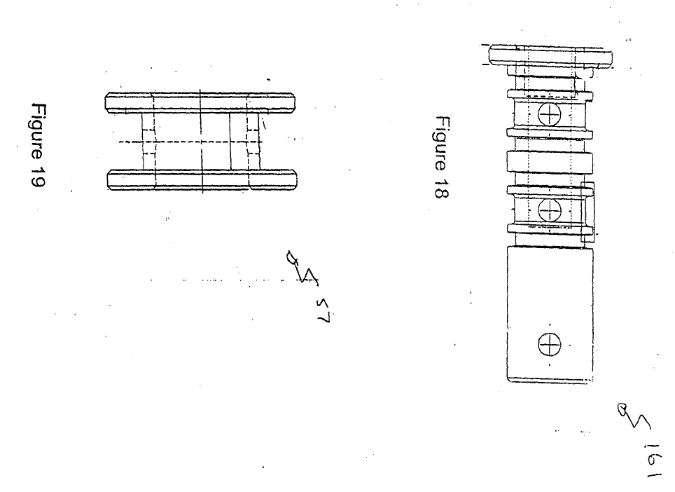

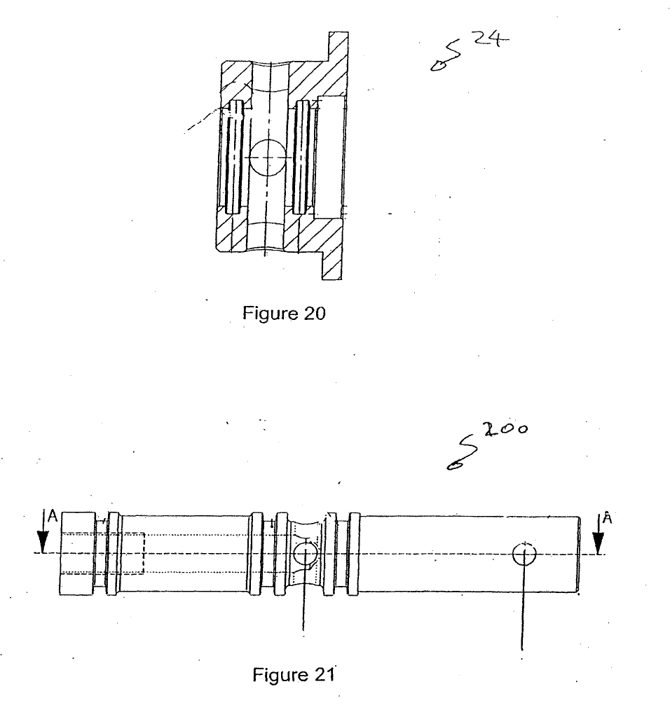

FIG. 17 shows bearing 50 or tray bush nylon bushing (bearing) to handle the turning motion of the trays 40. To add further support, the cradle 15 can include a central support member 49 including means 47 to support the tray 40 and a middle support bearing or bush 57 as shown in FIG. 19. The end bush (bearing) is for a stainless steel shaft holding the trays 40. The means 47 can include an outside frame with a plurality of support members 69 located about a pair of openings 70.

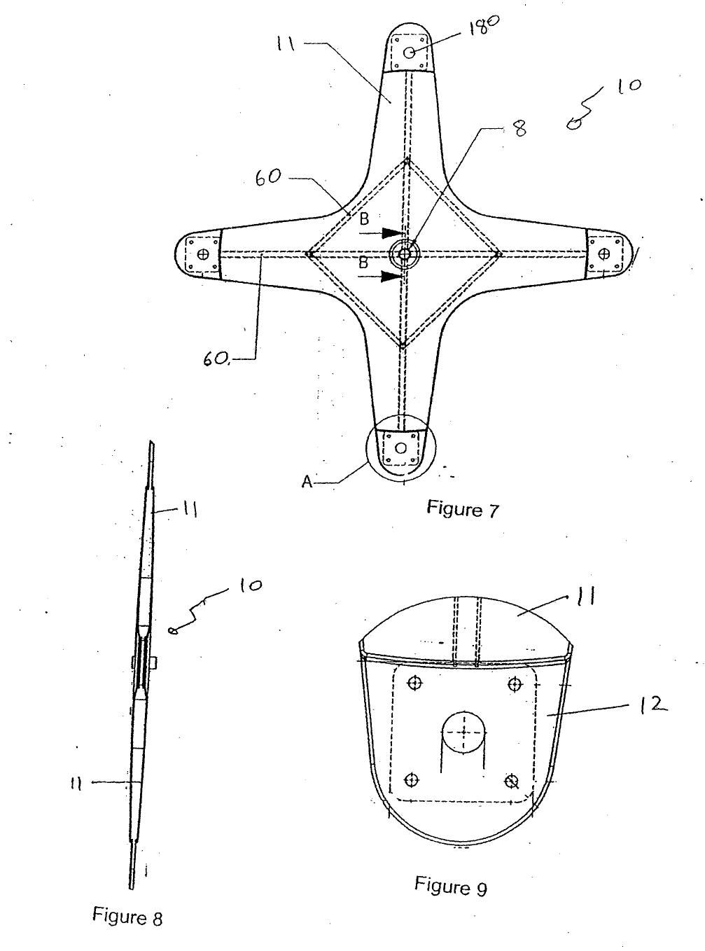

As best seen in FIGS. 7 and 11, the end members 10 and 100 can include watering means 60 in the form of piping or the like. The piping 60 runs water from the main shaft 8 along the arms 11, 110 of the end plates 10, 100 to irrigate the plants located in the trays 40. The main shafts 8, 80, arm shafts 14, 140 and fittings can include passages 180 along which water can flow. Holes (not shown) are located in the shafts 14, 140 through which the water can be dispersed onto the plants in the tray 40. The apertures 43 and end members 41 being provided to allow excess water in the trays 40 to flow to the collector 25 and be returned back into the system.

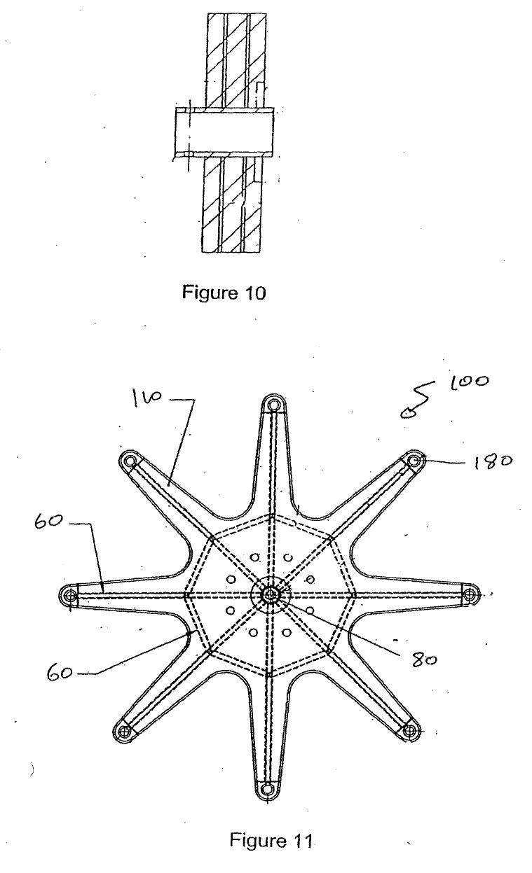

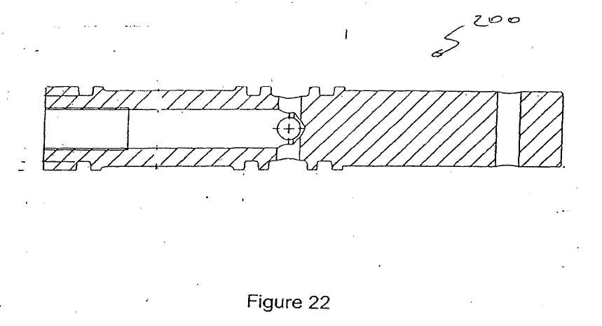

FIG. 10 shows a section BB of FIG. 7 showing a nylon bearing to hold the turning shaft 140. FIG. 18 shows the tray 40 pivot pin 161 another nylon bearing to hold the turning shaft 140 and allow the passage of water. FIGS. 21 and 22 show the main inlet 20 and are preferably nylon allowing turning of a stainless steel shaft 140 and the passage of water.

In the preferred form all the shafts 8, 80, 140 are all stainless steel and all bearings or bushes are nylon. The main bearings allow passage of water while the removing bearings are just to handle movements of the trays. The large or main end plate or wheel (11) rotates to regulate sunlight to even out crops. The smaller or arm end plates or wheels 100 can be turned by hand for easy planting and pickings of crops. The motor to rotate the main shaft 8 would be mounted on the bridge 20 however could be located in any position. There could also be more than one motor or a motor for each carousel.

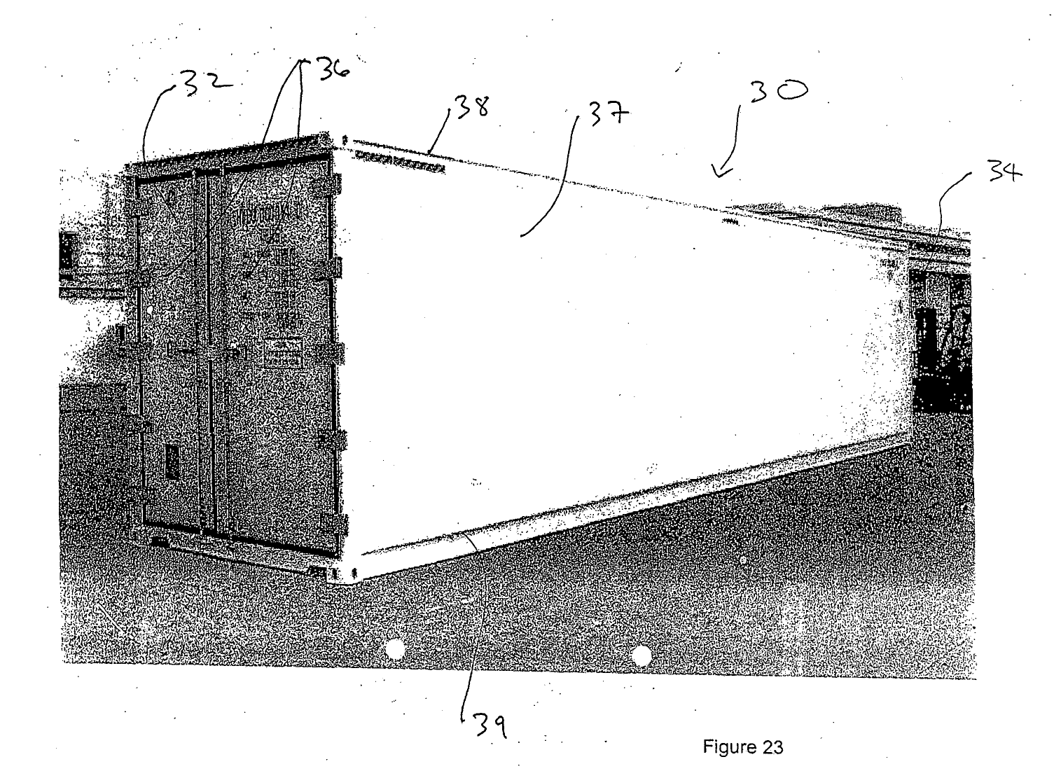

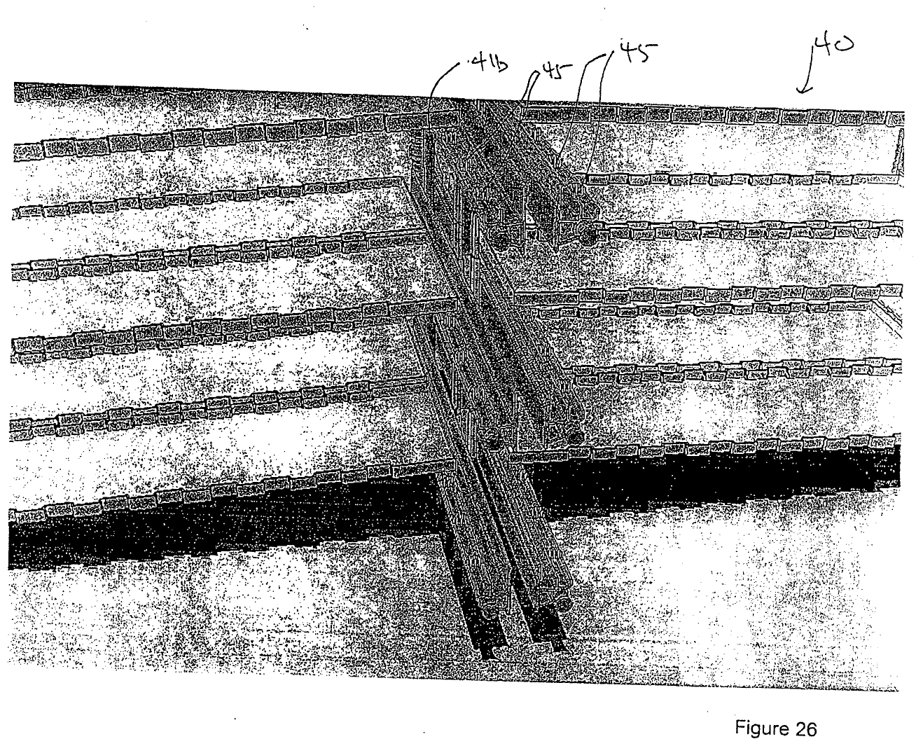

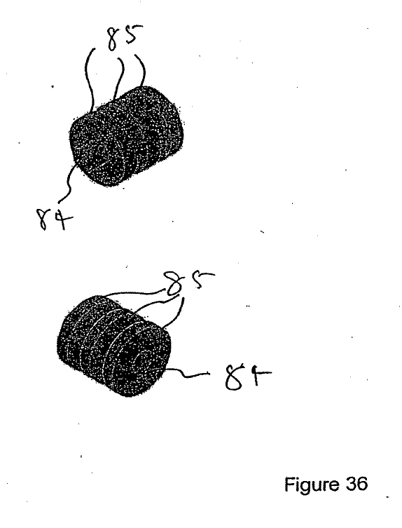

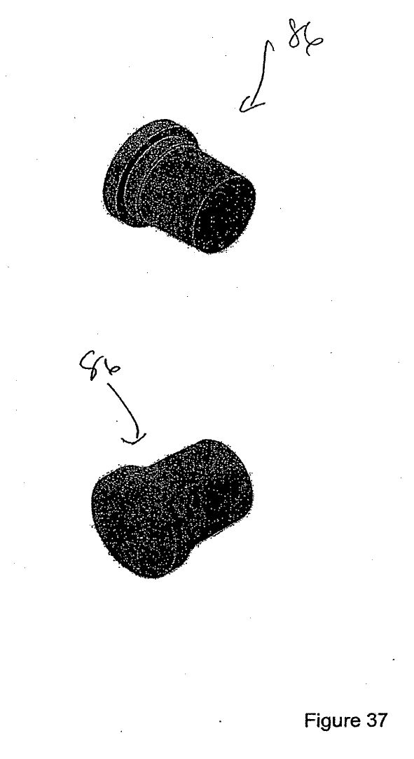

Referring to FIGS. 23 to 43 there is disclosed an assembly for growing barley as fodder from sprouted barley seedlings. In the preferred embodiment, a separate container (not shown) is used for sprouting barley from seeds into seedling sprouts. The seedling sprouts are then transferred to the assembly of the present preferred embodiment to be grown into barley for use as fodder.

FIG. 23 shows an elongated rectangular prism container 30 which houses therewithin a plant growing assembly 40 according to the preferred embodiment. The container 30 includes side walls 37, a roof 38, a floor 39, an entry end 32 and an exit end 34. Each of the entry and exit ends 32 and 34 has doors 36 for selectively opening and closing same. The container is mounted on the ground with the entry end 32 elevated relative to the exit end 34, to provide a 20° downward angle for the floor 39 from the entry end 32 to the exit end 34. The purpose of this 20° angle is described below. The container 30 in the embodiment is a 40 foot commercial container.

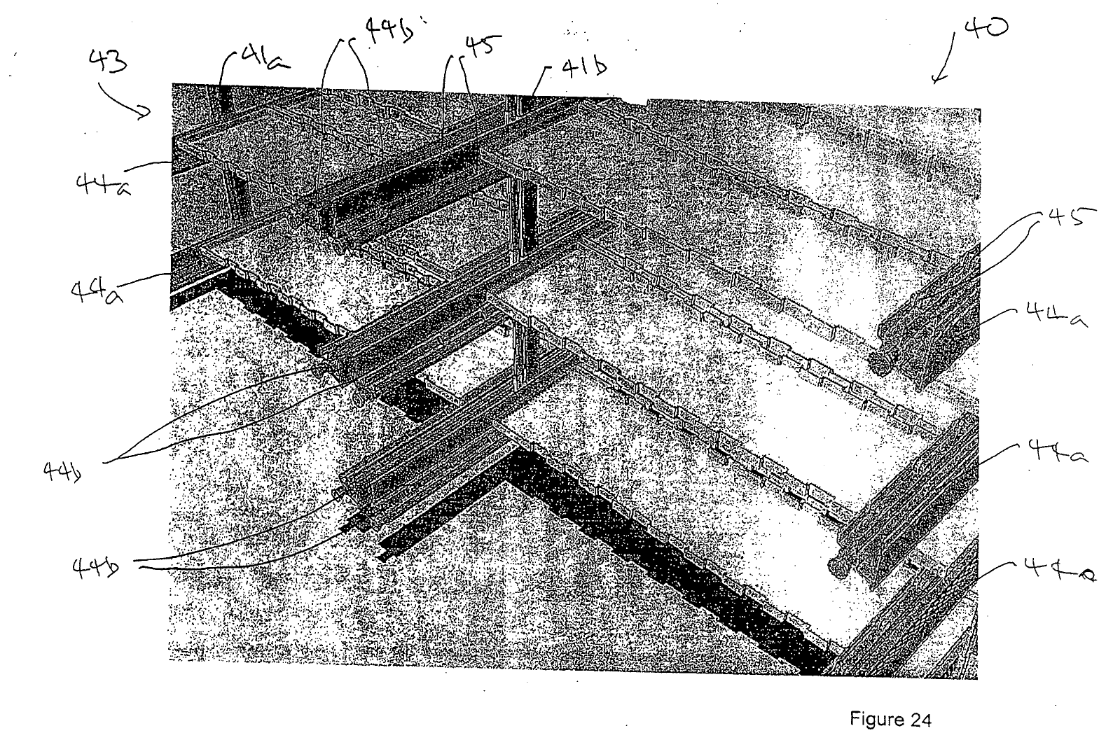

FIGS. 24 to 26 show the plant growing assembly 40 assembled within the container 30. The assembly 40 includes sets 43 of vertical support beams spaced along the length of the container 40. Each set 43 comprises a pair of side vertical support beams 41a and a middle vertical support beam 41b disposed midway between the side beams 41. The support beams 41 extend between and are mounted to the container floor 39 and roof 38. The side support beams 41a along each side of the container 30 together support substantially horizontal side brackets 44a on sides thereof facing the middle of the container 30. In the assembly 40, the side beams 41a of each side support seven vertically spaced brackets 44a. The middle support beams 41b support seven substantially horizontal middle brackets 44b at each lateral side thereof, with each middle bracket 44b being paired with a side bracket 44a. The brackets 44 are attached to each support beam 41 via a collar 60. Each of the brackets 44a and 44b extends longitudinally along the length of the container 30 and include a plurality of rollers 45 spaced along top portions thereof. Each of the bracket pairs 44a and 44b support trays 46 which are movable therealong via the rollers 45. The middle brackets 44b are positioned to be slightly higher than their corresponding side bracket 44a such that each tray 46 is angled about 20° downwardly towards the side brackets 44a. The assembly 40 thus provides seven vertical levels of tray rows with each level providing two longitudinal tray rows, providing a total of 14 tray rows.

Details regarding the components of the assembly 40 will now be described.

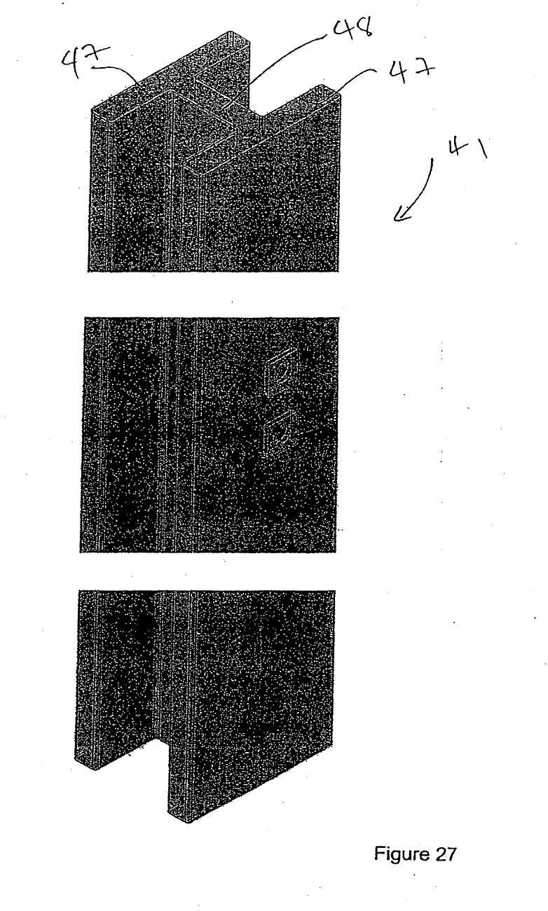

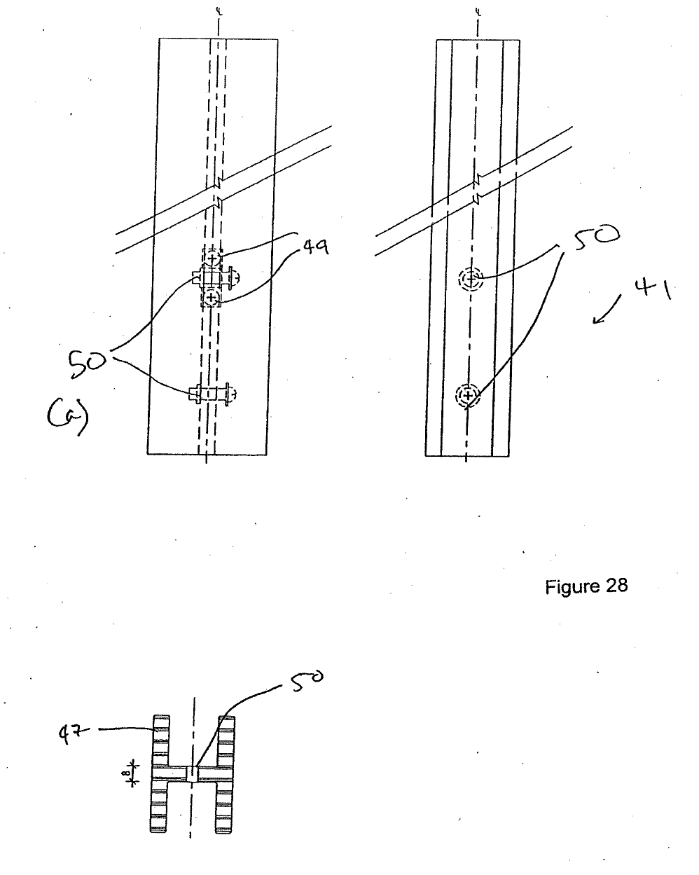

FIGS. 27 and 28 show a support beam 41. Each support beam 41 is an H beam, meaning that the beam 41 has a substantially H-shaped cross section comprising parallel sides 47 and a web 48 extending therebetween.

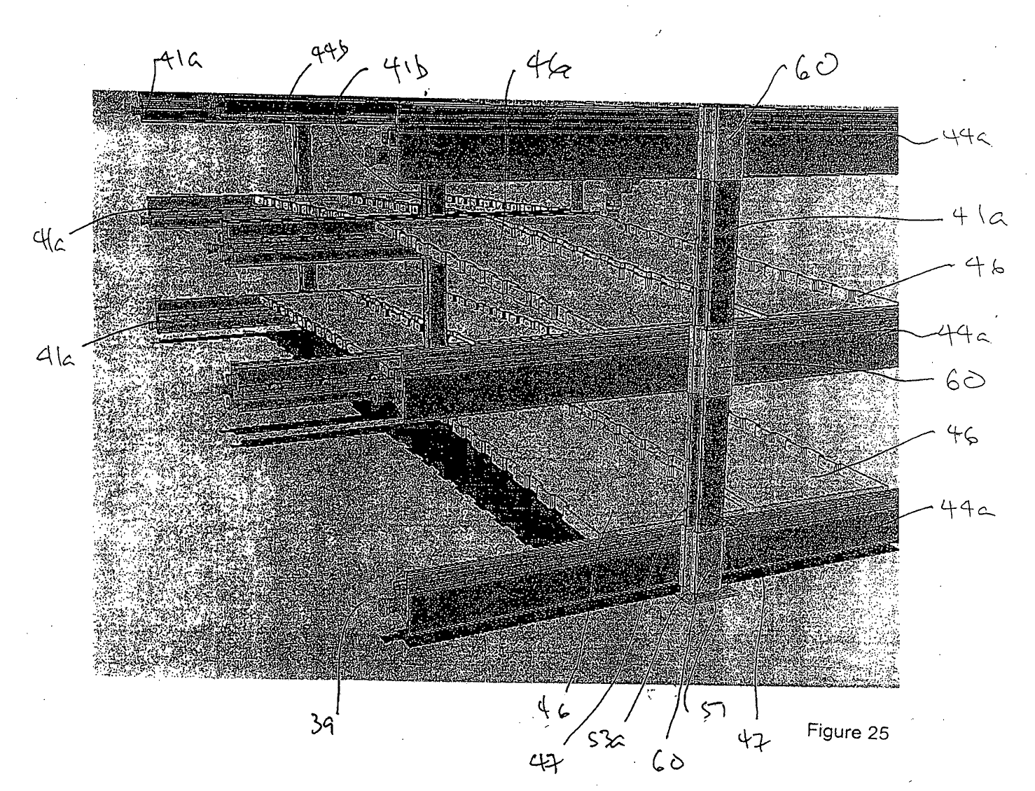

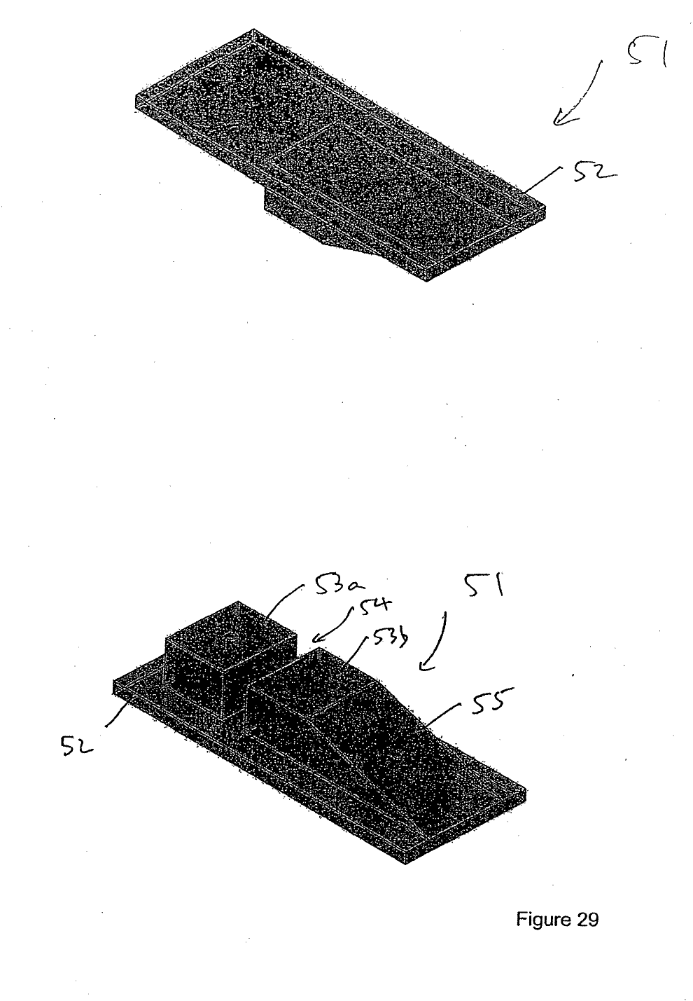

FIG. 29 shows fixing plates 51 used for mounting the support beams 41 at their upper and lower ends to the container roof 38 and floor 39. Each fixing plate 51 comprises a base plate 52 and first and second rectangular prism formations 53a, 53b attached thereto and spaced from each other by a gap 54. A ramp 55 extends from the baseplate 52 to the top surface of the second formation 53b at a side thereof opposite to the gap 54. Screw holes 56 are formed in the formation 53a and the ramp 55 for mounting the fixing plates 51 to the container. A pair of the fixing plates 51 is required for each support beam 41 with one fixing plate 51 attached to the container floor 39 and the other attached to the container roof 38. The support beam web 48 is inserted in the gap 54 (see FIG. 25). The ramp 55 can be used for assisting in placing the web 48 within the gap 54.

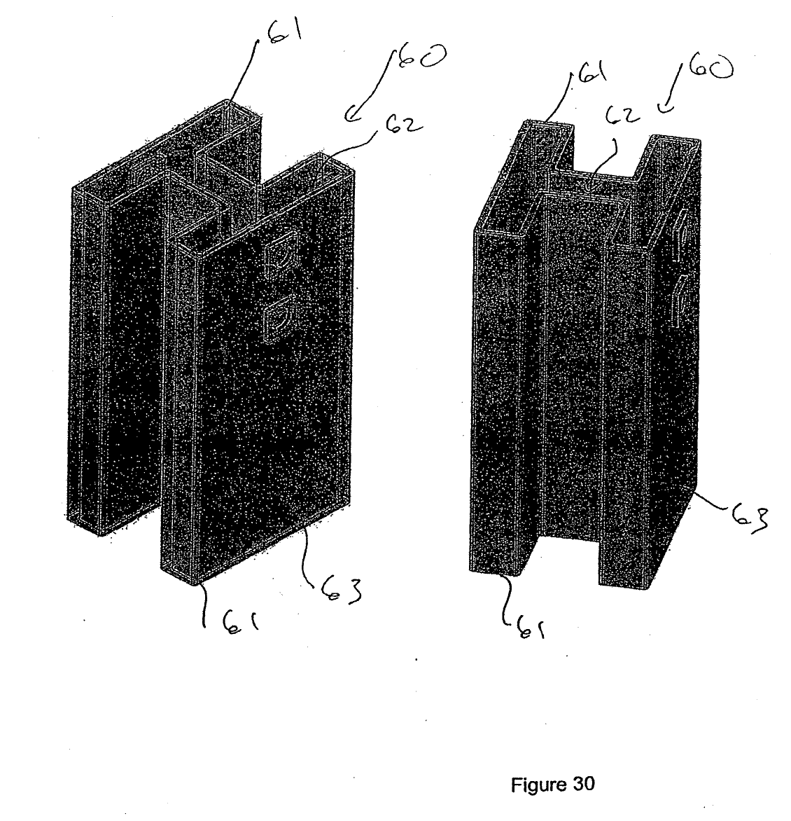

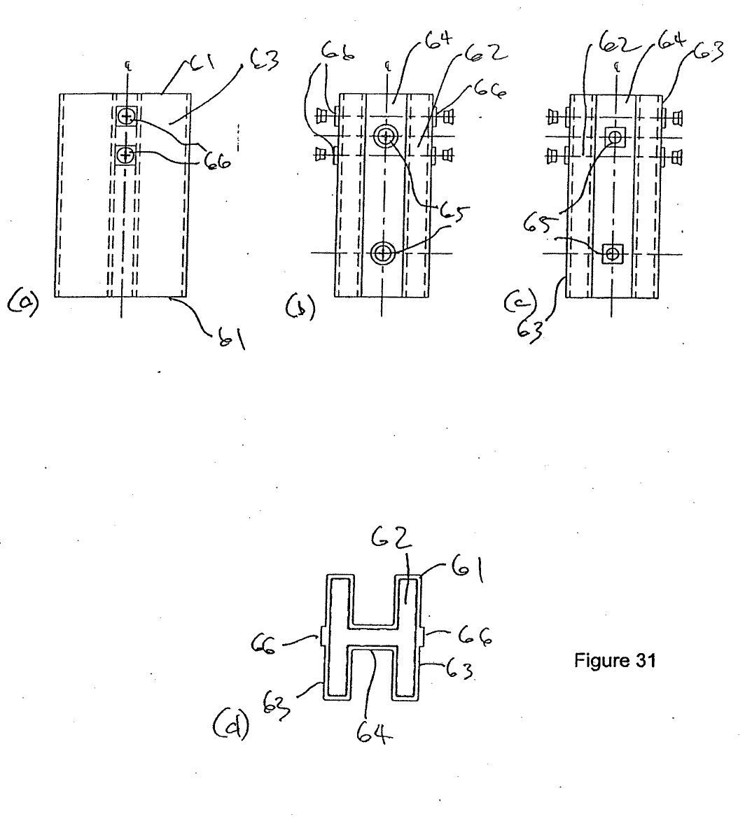

FIGS. 30 and 31 show a collar 60 for fixing a bracket 44 to a support beam 41. The collar 60 is an elongated hollow formation having side faces 63, middle web 64, open ends 61 and an H-shaped passage 62 extending between the ends 61. The passage 62 is shaped similar to the cross section shape of the support beam 41 such that the support beam 41 can be inserted therethrough. The collar 60 is then slidable along the support beam 41. The middle web 64 includes threaded beam attachment apertures 65 for fixing the collar 60 to the support beam 41. The side faces 63 include raised threaded bracket attachment apertures 66 for fixing a bracket 44 to the collar 60.

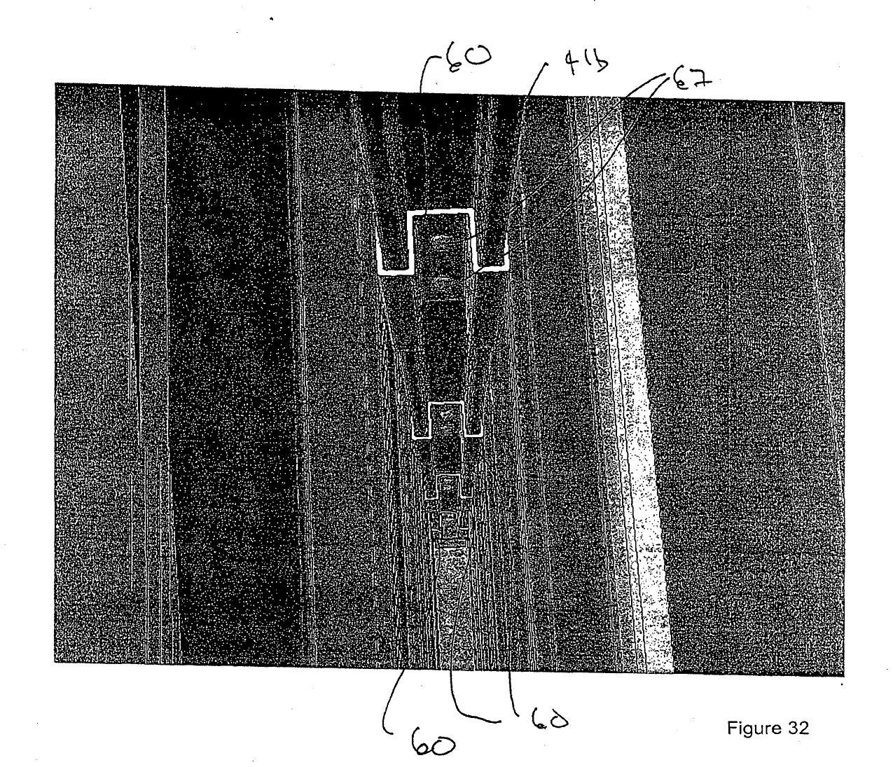

FIG. 32 shows a number of collars 60 attached to the middle support beam 41b and FIG. 3 shows a number of collars 60 attached to the side support beam 41a. A collar 60 attaches each bracket 44 to the support beam 41 and thus, each support beam 41 includes seven collars 60. As shown in FIG. 32, attachment screws 67 are inserted in the beam apertures 65 to fix each collar 60 in its desired position to the support beam 41.

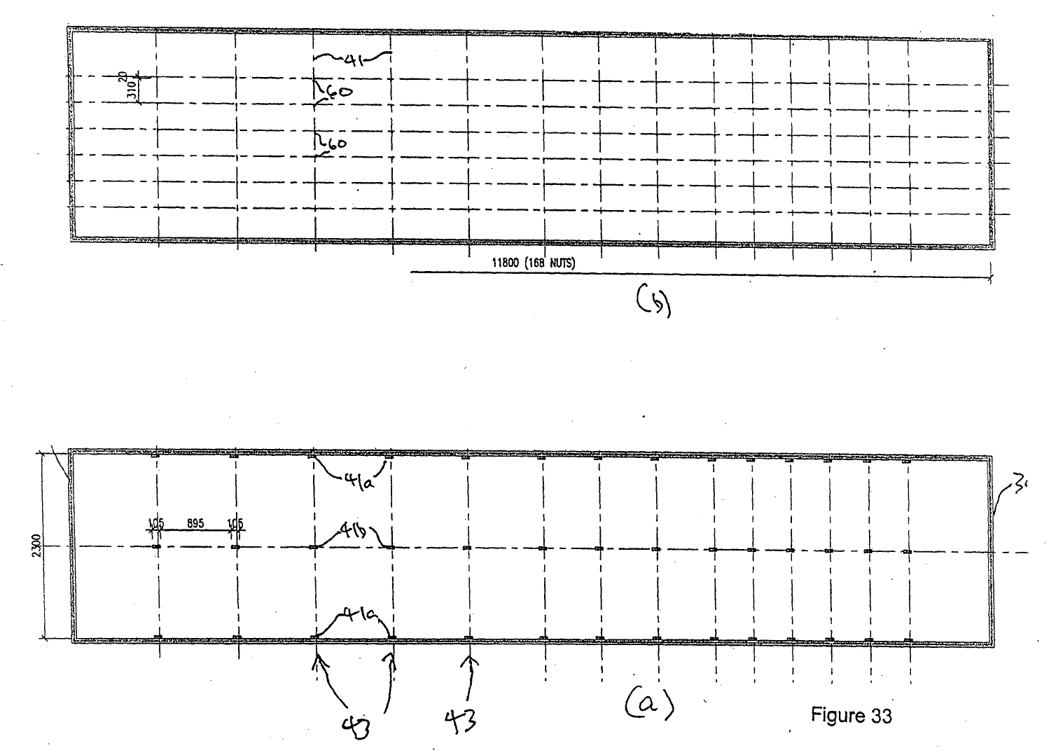

FIG. 33(a) shows the spacing of the support beams sets 43 along the container 30. Adjacent the entry end 32 to about halfway the length of the container 30, the support beam sets 43 are about 1000 mm apart. The next sets 43 are then spaced about 750 mm apart up to about three-quarters the length of the container 30. The next sets 43 are then spaced about 500 mm apart up adjacent the exit end 34. The narrower spacing of the sets 43 adjacent the exit end 34 is due to the trays 46 getting heavier as they approach the exit end 34 as the barley grows, as further described below.

FIG. 33(b) shows the spacing of the collars 60 along the support beams 41. As shown, the collars 60 are substantially evenly spaced at 330 mm gaps to each other. The gap between the collars 60 can be adjusted as desired, to cater for growing different plants in the assembly 40.

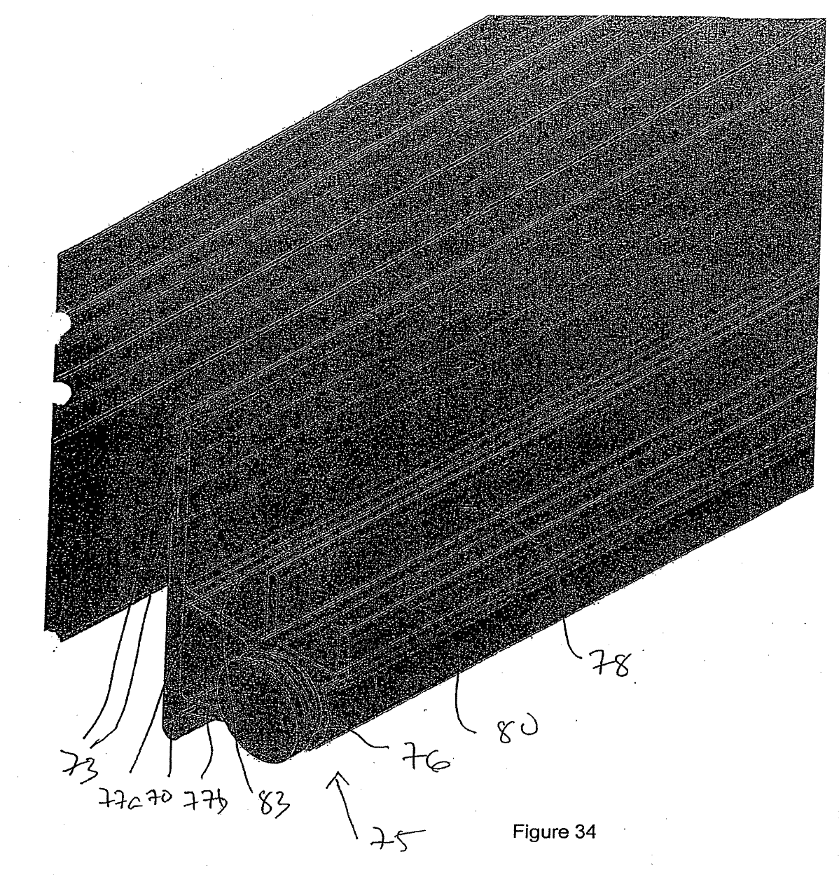

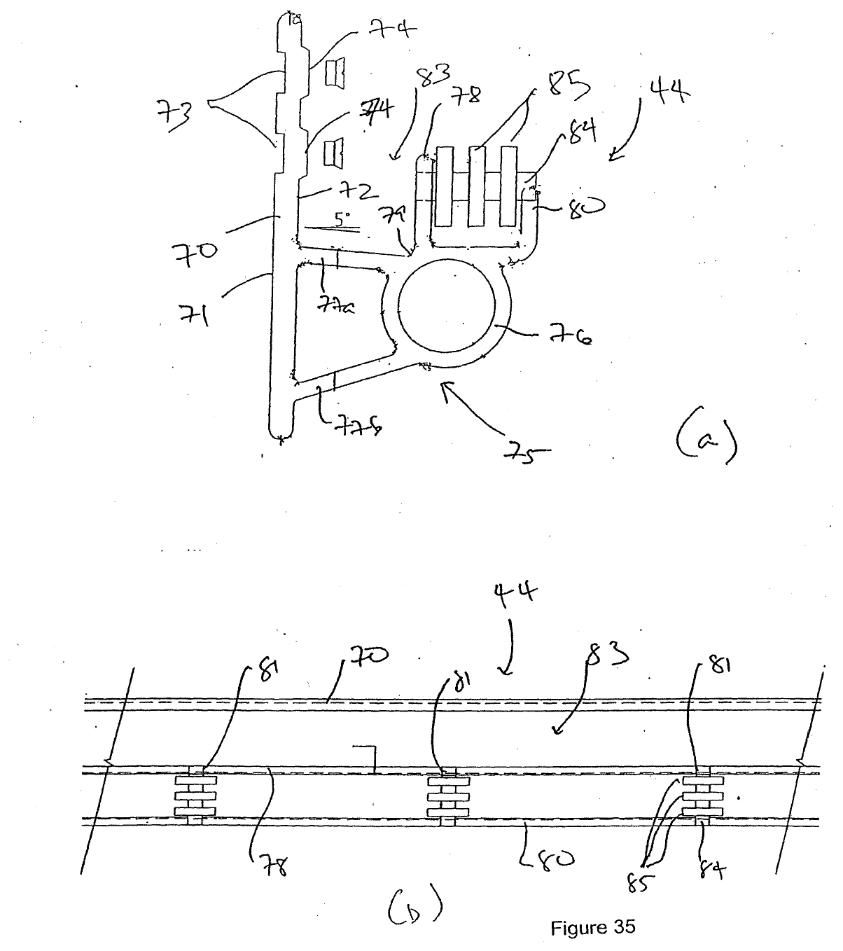

FIGS. 34 and 35 show a bracket 44 which is extruded from metal or plastic. Each bracket 44 includes a vertical attachment plate 70 having a first side 71 and a second side 72. The first side 71 includes two vertically spaced longitudinal recesses 73 at an upper portion thereof, which includes a number of threaded apertures 74 spaced along the length of the bracket 44. The recesses 73 in use received the collar raised apertures 66 for positioning the bracket 44 to the collar 60.

The second side 72 includes a formation 75 at a lower end of the attachment plate 70. The formation 75 includes a tube 76 attached to the plate 70 via upper and lower webs 77a and 77b. The formation 75 also includes a first vertical wall 78 above the tube 76 adjacent a junction 79 between the upper web 77a and the tube 76. The plate 70, upper web 77a and first wall 78 form a channel 83 therebetween. As shown in FIG. 35(a), the upper web 77a is angled 5° downwardly toward the tube 76.

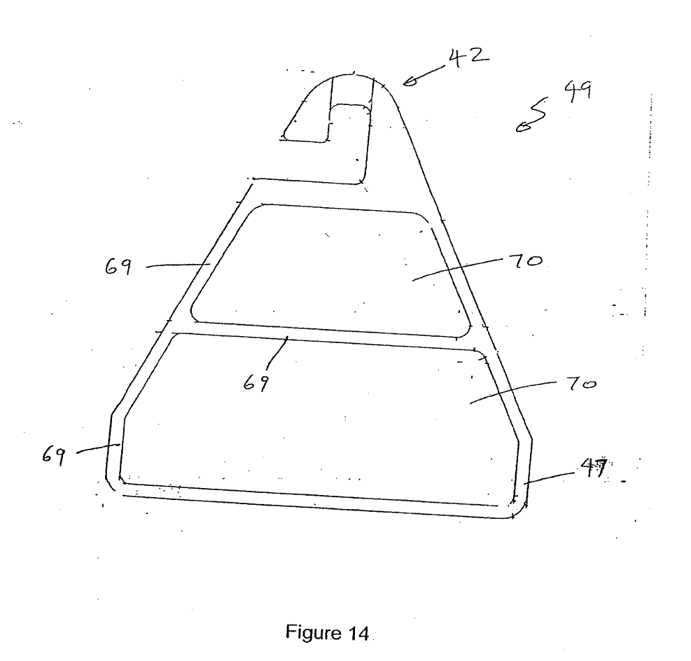

The formation 75 includes a second vertical wall 80 spaced from the first vertical wall 78 and located adjacent a distal peripheral end of the tube 76. The height of the second wall 80 is about half the height of the first wall 78. The first wall 78 includes a number of holes 81 therein spaced longitudinally therealong and the second wall 80 includes half-hole recesses 82 therein corresponding to the holes 81. The hole 81 and recess 82 pair receive and rotatably retain therein a shaft 84 of a roller 45. FIG. 14 shows the rollers which include the shaft 84 having three support discs 85 spaced thereon.

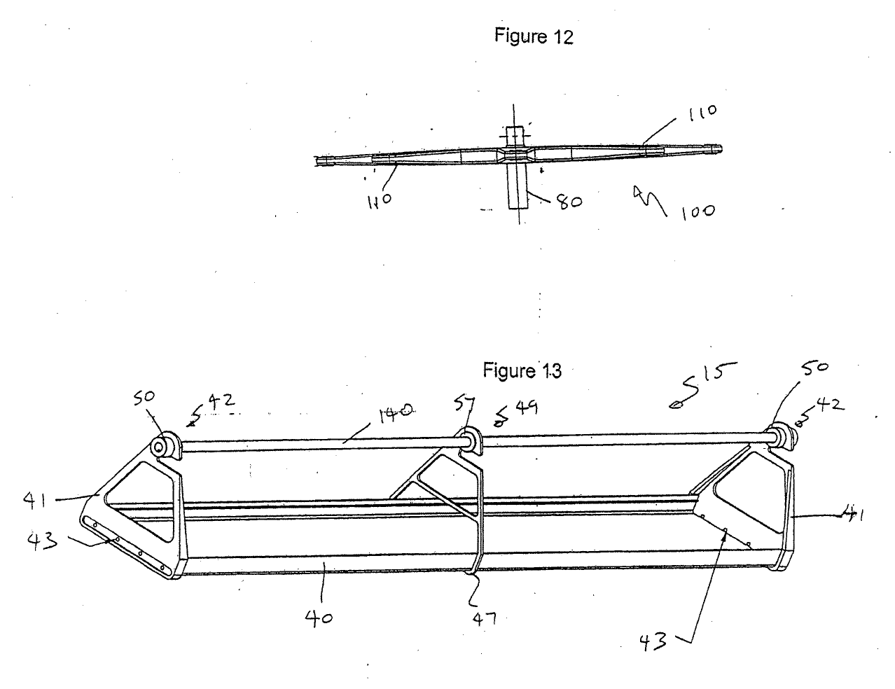

FIG. 37 shows a plug 86 for the tube 76, which includes a tapered body which (as shown in FIG. 12) can be used to close an open end of the tube 76.

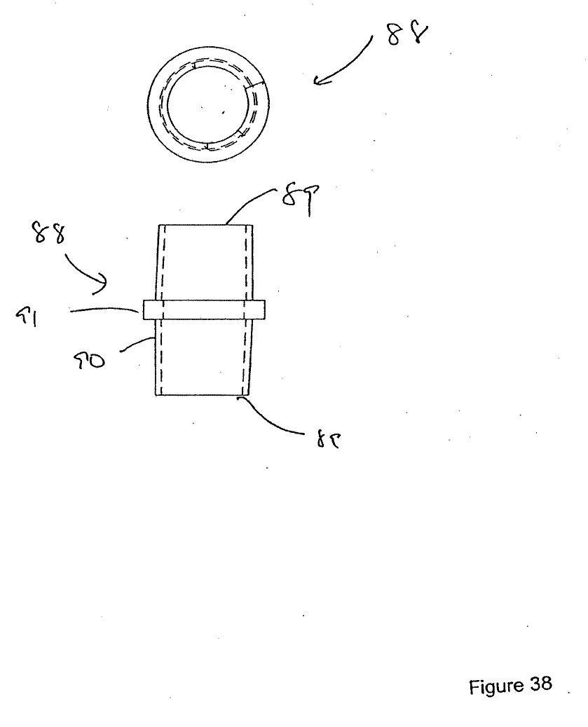

FIG. 38 shows a joiner 88 for connecting the tubes 76 of two brackets to each other. The joiner 88 has a hollow generally cylindrical body 90 having open ends 89. The body 90 is tapered from the open ends 89 toward an enlarged disc 91 at a middle portion thereof. In use, one end 89 can be inserted into a tube 76 of one bracket 44 and the other end 89 can be inserted into the tube 76 of another bracket 44, such that the tubes 76 are connected. The joiner 88 allows multiple brackets 44 to be connected to each other.

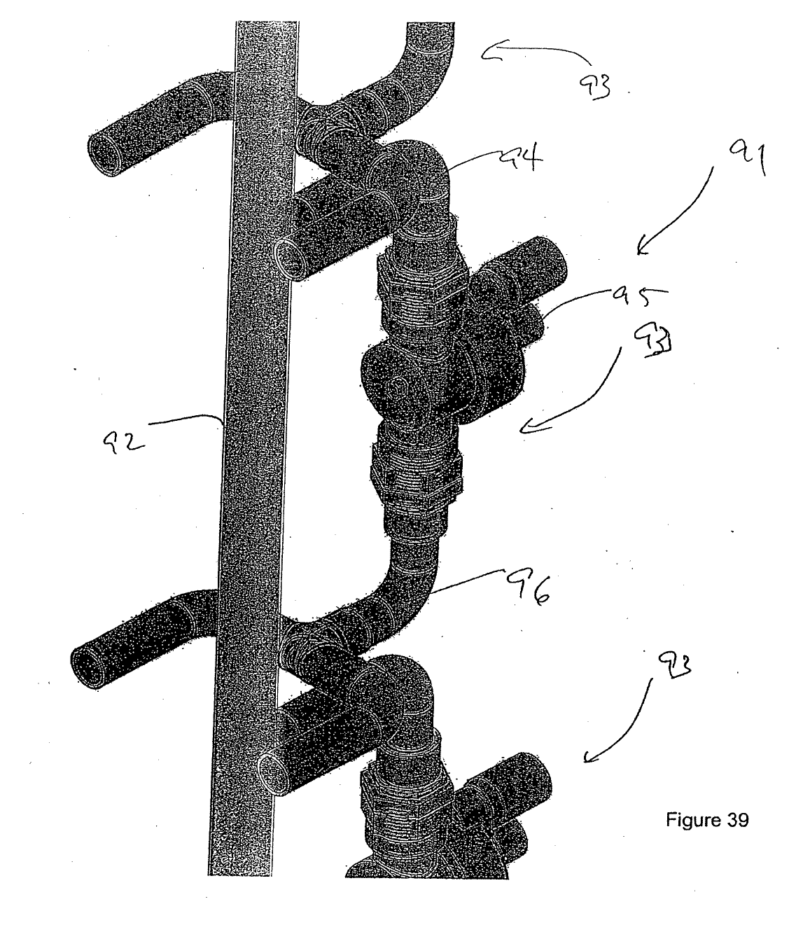

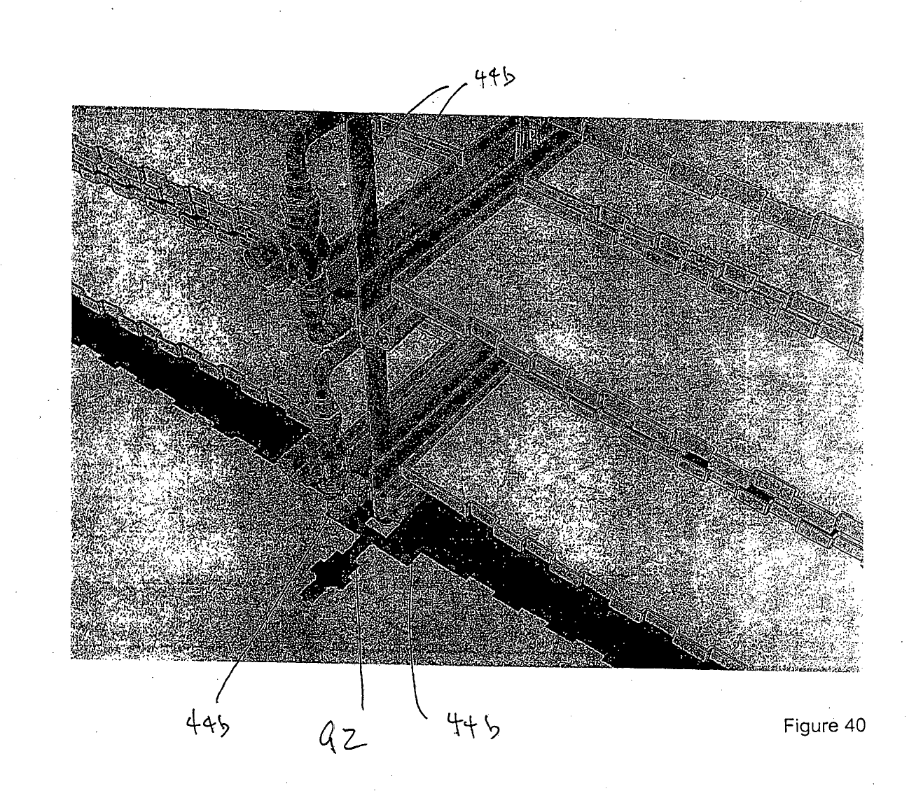

FIG. 39 shows a portion of a nutrient delivery system 91 for distributing and collecting nutrient water to and from the tubes 76. The nutrient delivery system 91 includes a vertical conduit 92 connected to a tank (not shown) for storing nutrient water. The conduit 92 extends at the exit end of the assembly 40 between the middle brackets 44b as shown in FIG. 40. The tank is connected to a pump (not shown) for delivering nutrient water to the conduit 92. The delivery system 91 includes seven distribution sub-assemblies 93 vertically spaced along the conduit 92, each corresponding to a level pair of the middle brackets 44b. Each sub-assembly 93 includes an inlet branch 94 connected to a solenoid valve 95 which is connected to a Y-shaped two outlet branch 96. The inlet branch 94 is connected to the conduit 92 and the two outlets of the outlet branch 96 are respectively connected to the pipes 76 of one level of the middle brackets 44b. Thus, nutrients from the delivery pipe 92 can be delivered to the middle bracket pipes 76. The nutrient delivery system 91 also includes return conduit pipes (not shown) attached to the side bracket pipes 76 for returning nutrient excess to the tank.

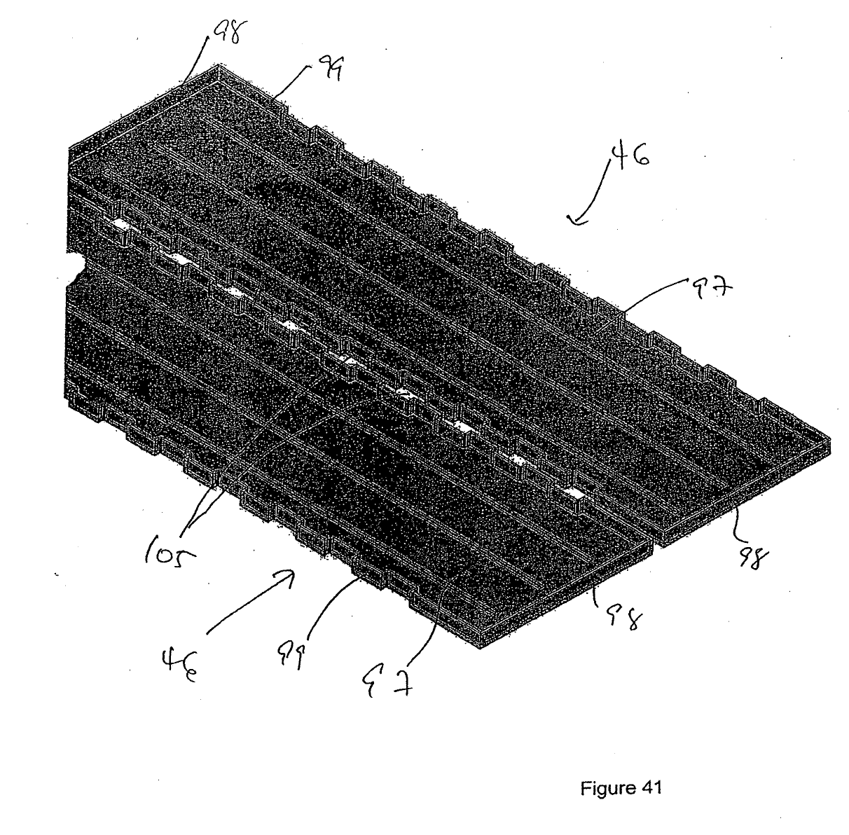

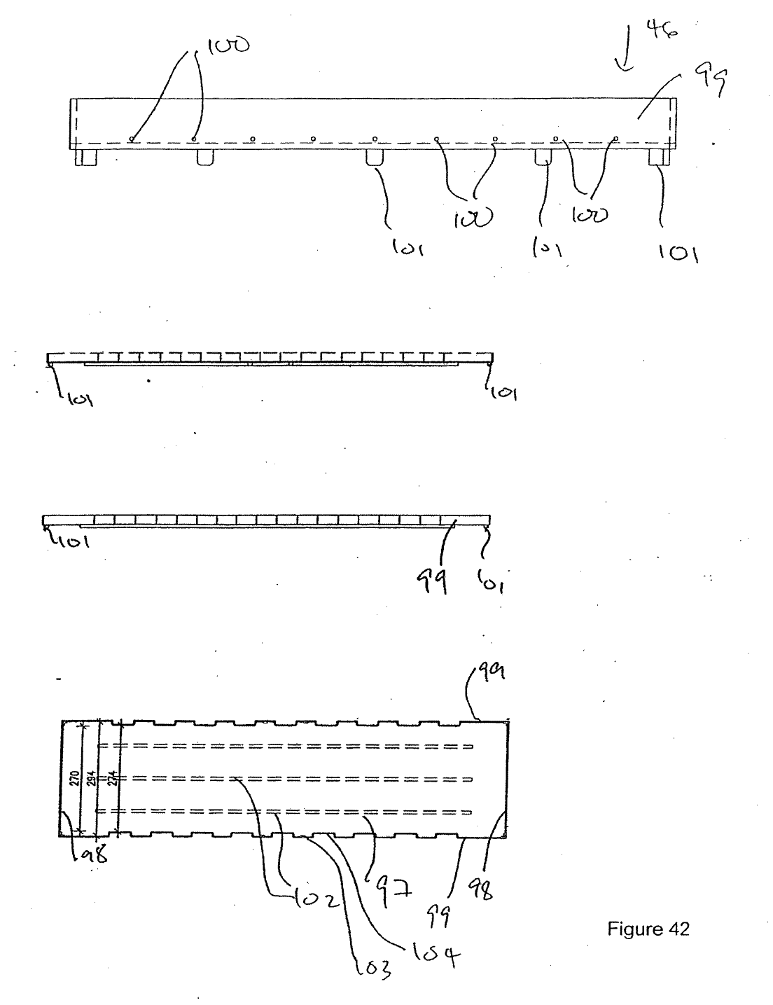

FIGS. 41 and 42 show the trays 46 for use in the assembly 40. The trays 46 include a generally flat and elongated base 97, end walls 98 and side walls 99. The end walls 99 include spaced drainage holes 100 formed therein. Stiffener tabs 101 are formed at a lower surface of the base 97 adjacent the end walls 99. The base 97 also includes three spaced longitudinal channels 102 formed therein extending between the end walls 99. The tray side walls 99 have a profile which in plan includes a series of first walls 103 connected to offset walls 104 spaced from the first walls 103 towards the middle portion of the base 97. The series of first walls 103 and offset walls 104 together form a substantially corrugated plan profile for the side walls 99. This side wall profile provides apertures 105 between two adjacent trays 46 when trays 46 are laid side by side. The apertures 105 are about 1 cm wide and allow for airflow between the trays 46 which assists in the growth of the seedlings.

The present invention also includes an air conditioning system which regulates the temperature and humidity within the container to provide for optimum growth of the seedlings.

Use of the assembly 40 will now be described.

Each day, sprouted seedlings are transferred onto forty trays 46. The trays 46 are placed into each of the seven levels of bracket pairs 44 at the container entry end 32. Each following day, a further forty trays 46 of sprouted seedlings are loaded onto the assembly 40. Each tray 46 being loaded is used to push the previously loaded trays 64 along the rollers 45 further toward the container exit end 46. The trays 46 travel the length of the container 30 over a period of six days and where they are provided with nutrient water and where air flow and humidity within the container 30 is maintained. After six days, the barley has grown from seedlings to a height sufficient for use as fodder with each tray holding about 25 kg of barley. Forty trays of grown barley (1 tonne total) are then harvested at the exit end 34 for use as feed. The 40 foot container 30 when full can hold 518 trays.

The container 30 and its ducted air conditioning system (designed by Actron Air Pty Ltd) is designed to have an air circulation capacity of 68-70 cubic metres per hour and to regulate the humidity at 60-65%.

Irrigation of the trays 46 with nutrient water will now be described.

The nutrient delivery system 91 is used to deliver nutrient water to the middle bracket tubes 76. Spray holes (not shown) are formed along the length of the middle bracket tubes 76 for spraying nutrient water to flood the respective trays 46 below the tube 76. The trays 46 along the top level are sprayed by a separate spray assembly (not shown). Each tray 46 is then flooded with nutrient water which flows therealong toward the side brackets 44a. Excess nutrient water flows though the drainage holes 100 adjacent the side brackets 44a and into the channel 83 (see FIG. 35a) of the side brackets 44a. The side brackets 44a include apertures (not shown) adjacent the junction 79 for allowing the nutrient water in the channel 83 to enter the side bracket tube 76. The side bracket tube 76 then returns the nutrient water back to the tank. The 20° downward angle of the container 30 between the entry and exit ends 32, 34 thereof assist in draining the nutrient water from the side bracket tubes 76 as well as when pushing trays 46 toward the exit end 34.

Although a preferred embodiment of the present invention has been described, it will be apparent to skilled persons that modifications can be made to the above embodiments or that the invention can be embodied in other forms. The method and assembly can be applied for growing of fodder from any other type of seedling such as wheat or any other cereal grain. The method and assembly can also be used with other types of trays for growing vegetables such as bok Choy.

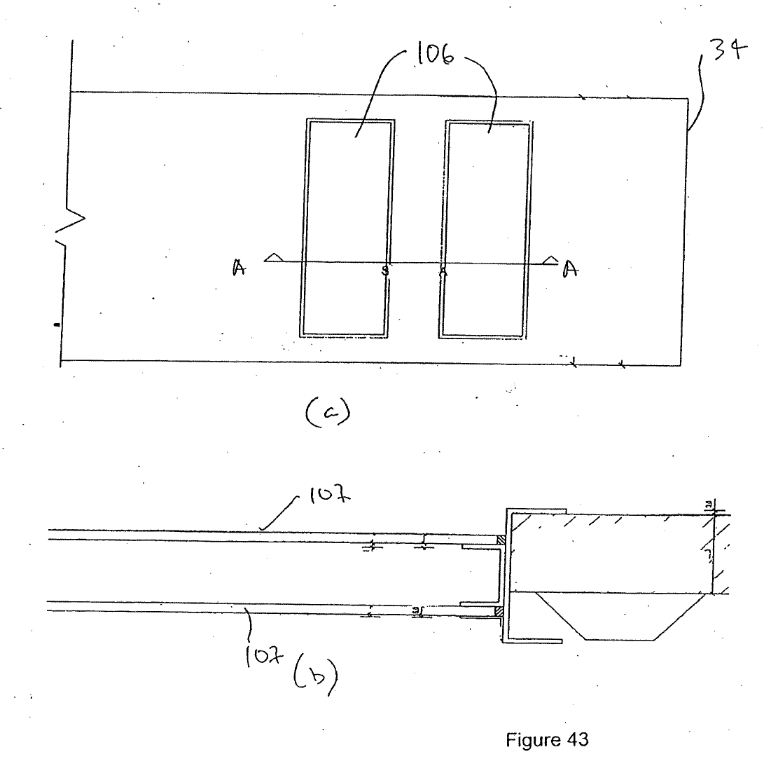

In another embodiment shown in FIG. 43, the container 30 has an outer shell and an insulated interior with lining of stainless steel. Adjacent the exit end 34, the container side walls 37 include two double glazed windows 106 spaced 1500 mm from the exit end 34 and 550 mm away from each other. The window panels 107 are 6 mm thick laminated glass windows with reflective glazing on the outside surfaces thereof. The panels 107 are 750 mm wide and 2300 mm high. The windows 106 allow sunlight into the container which allows the barley to produce chlorophyll and increases their sugar content.

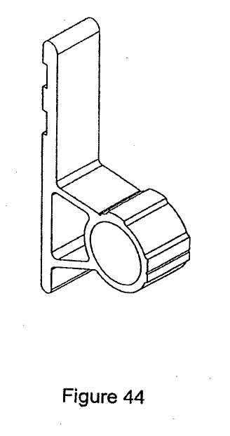

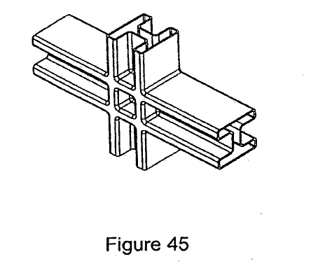

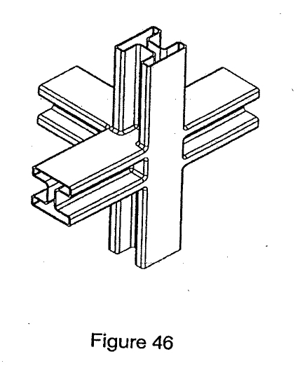

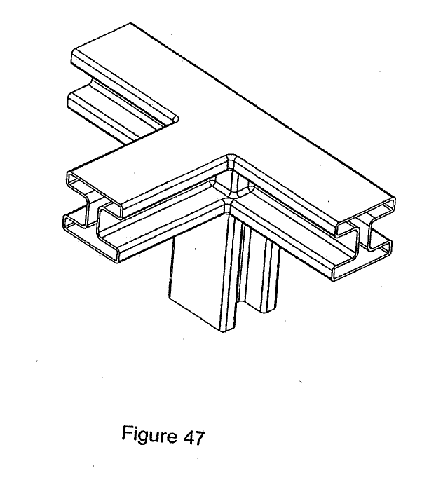

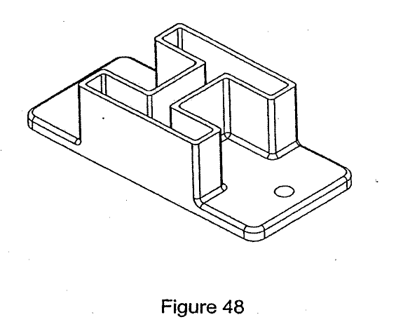

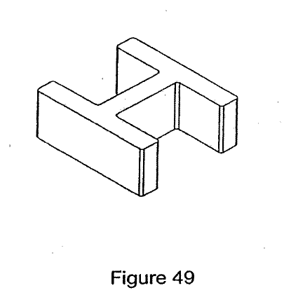

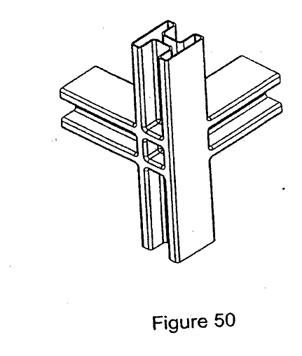

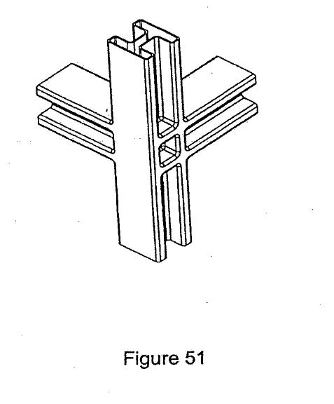

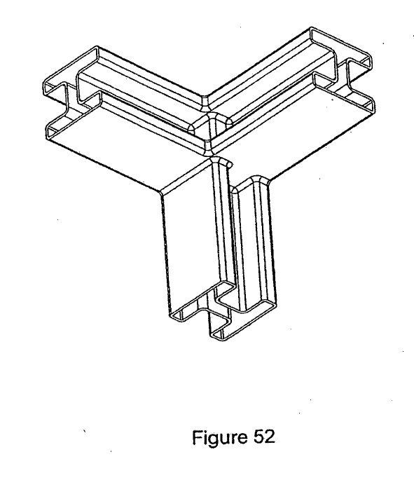

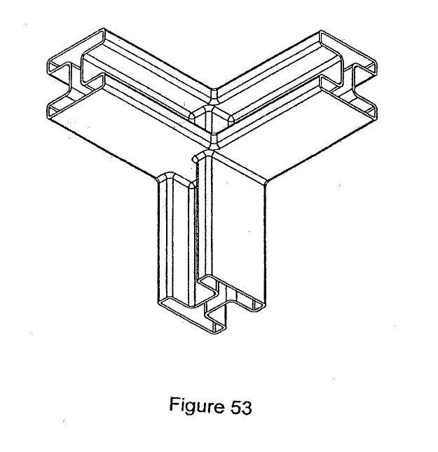

FIGS. 44 to 53 show further extruded parts for use with the invention disclosed herein.

Although the invention has been described with reference to specific examples, it will be appreciated by those skilled in the art that the invention may be embodied in many other forms. For example, in one embodiment all of the growing is done in a hydroponic style without moving the plants from small pot, to medium pot to large pot. The carousel arrangement allows planting in one setting, seed to plant with a clean root system.

1-38. (canceled)

39. An assembly for growing plants including:
a frame having a pair of laterally spaced apart frame members, and each the frame member having a main housing to be located above a surface;
a longitudinally extending main shaft to extend between the main housings, the main shaft defining a longitudinal axis about which the main shaft can rotate;
an end plate positionable adjacent each the main housing and securable to the main shaft to rotate about the axis;
each the end plate having at least two arms, a distal end of each the arm having an arm housing to support an arm shaft extending laterally between corresponding arms of corresponding end plates; and
a cradle to grow plants securable to the arm shaft and movable about the main shaft.

40. The assembly for growing plants according to claim 39, wherein each the frame member includes a bridge portion and a pair of longitudinally extending outwardly diverging legs, feet are positioned adjacent a distal end of the legs and locatable on the surface, and the main housing being located adjacent the bridge portion.

41. The assembly for growing plants according to claim 9, wherein the frame member is substantially “A” shaped.

42. The assembly for growing plants according to claim 39, wherein each the main housing includes at least one bearing adapted to support rotation of the main shaft.

43. The assembly for growing plants according to claim 39, wherein each the end plate is a first end plate and the arm shafts are second main shafts, the assembly including second end plates located adjacent the arm housings and adapted to rotate about the second main shafts, the second end plates having at least two arms adapted to support respective arm shafts and respective cradles.

44. The assembly for growing plants according to claim 43, wherein each the cradle includes a longitudinally extending tray located between a pair of end members, the end members having means to attach the cradle to a respective arm shaft, and the tray is movable relative to the arm shaft so as to maintain the tray in a substantially horizontal orientation relative to the surface during use.

45. The assembly for growing plants according to claim 44, wherein the attachment means of the cradle includes a hook portion.

46. The assembly for growing plants according to claim 44, further including watering means operatively associated with the trays to water the plants being grown in the cradles during use.

47. The assembly for growing plants according to claim 46, wherein the watering means includes a pipe extending along at least one arm of at least one end plate.

48. The assembly for growing plants according to claim 46, wherein the watering means includes a pipe extending along each the arm.

49. The assembly for growing plants according to claim 44, wherein the end members of the trays include apertures to provide access for water to flow.

50. The assembly for growing plants according to claim 46, including a water collector to receive water from the watering means, and the collector has a portion located closer to the surface than the trays.

51. The assembly for growing plants according to claim 50, wherein the portion includes an arcuate receiving plate extending between a pair of end members.

52. The assembly for growing plants according to claim 39, the assembly includes a bracket for supporting one or more trays for the plant growing assembly, the bracket having:
a plate for attachment to the frame;
a formation including a tube attached to the plate via at least one web, a first wall extending above the tube, and the plate, web and first wall form a channel therebetween.

53. The assembly for growing plants according to claim 52, wherein the formation includes a second wall locatable above the tube spaced from the first wall, and the first and the second walls are adapted for mounting rollers for receipt of the trays.

54. The assembly for growing plants according to claim 53, wherein the web is angled 5° downwardly toward the tube during use.

55. The assembly for growing plants according to claim 53, wherein the first and the second walls extend substantially vertically, and the second wall is located adjacent a distal peripheral end of the tube.

56. The assembly for growing plants according to claim 52, wherein the plate includes at least two vertically spaced longitudinal recesses which have threaded apertures thereon for positioning the bracket relative to the frame.

57. The assembly for growing plants according to claim 52, the frame including a slidable collar fixable in position to a support beam, and the bracket is attached to the collar during use.

58. The assembly for growing plants according to claim 39, wherein the assembly includes:
a pair of substantially vertical support beams spaced along the assembly;
brackets supported by the support beams on respective sides of the assembly, each bracket on one side is paired with a bracket on the other side and adapted for supporting a tray therebetween; and
each bracket is attached to a support beam by way of a slidable collar fixable in position relative to the support beam.

59. The assembly for growing plants according to claim 58, further including one or more sets of support beams which comprise a pair of side support beams and a middle support beam disposed midway between the side beams.

60. The assembly for growing plants according to claim 59, wherein the side beams support vertically spaced brackets on sides thereof facing the middle support beam and the middle support beams support substantially vertically spaced brackets at each lateral side thereof.

61. The assembly for growing plants according to claim 39, wherein at least one of:
the assembly is locatable within a container; and
the support beams extending between and mountable to a floor and roof of the container.

62. The assembly for growing plants according to claim 61, wherein the container includes an air conditioning system for regulating temperature and humidity within the container.

63. The assembly for growing plants according to claim 60, wherein the middle brackets are positioned to be slightly higher than their corresponding side bracket such that each tray is angled about 20° downwardly towards the side brackets during use.

64. The assembly for growing plants according to claim 61, wherein the container includes side walls, a roof, a floor, an entry end and an exit end, and each of the entry and the exit ends has at least one door for selectively opening and closing the container.

65. The assembly for growing plants according to claim 64, wherein the container is mountable on a ground surface with the entry end elevated relative to the exit end to provide a 20° downward angle from the entry end to the exit end during use.

66. The assembly for growing plants according to claim 52, wherein the assembly further includes a nutrient delivery system for distributing and collecting nutrient water to and from the tubes during use.

67. The assembly for growing plants according to claim 66, wherein the nutrient delivery system includes a conduit connected to a tank for storing nutrient water, a pump for delivering nutrient water to the conduit, distribution subassemblies spaced along the conduit, each subassembly including an inlet branch connected to a valve which is connected to an outlet branch, the inlet branch being connected to the conduit and the outlet connected to pipes, and the pipes include spray outlets for allowing nutrient water to be sprayed onto a tray below a respective pipe.

68. The assembly for growing plants according to claim 67, wherein nutrient water is supplied along one side of the assembly and excess nutrient water is collected at the other side, and the excess nutrient water adapted to flow into the tube by way of inlets spaced therealong to allow nutrient water to enter the tube.

69. The assembly for growing plants according to claim 68, wherein the excess nutrient water is transferred to a manifold connected to the tubes.

70. The assembly for growing plants according to claim 58, wherein the trays include a generally flat and elongate base, end walls and side walls, and the side walls include a substantially corrugated plan profile which forms apertures between two adjacent trays.

72. The assembly for growing plants according to claim 71, wherein at least one of:
the end walls include spaced drainage holes;
stiffener tabs are provided at a lower surface of the base adjacent the end walls;
the base includes spaced longitudinal channels extending between the end walls;
the side walls include a series of first walls connected to offset walls spaced from the first walls towards a middle portion of the base; and
the apertures between adjacent trays are about 1 cm wide.
